(19) United States
(12) Patent Application Publication
(10) Pub. No.: US 2002/0040299 A1
(43) Pub. Date: Apr. 4, 2002

(54) Apparatus and method for performing orthogonal transform, apparatus and method for performing inverse orthogonal transform, apparatus and method for performing transform encoding, and apparatus and method for encoding data

(76) Inventors: Kenichi Makino, Tokyo (JP); Jun Matsumoto, Kanagawa (JP); Masayuki Nishiguchi, Kanagawa (JP)

Correspondence Address: JAY H. MAIOLI, Cooper & Dunham LLP, 1185 Avenue of the Americas, New York, NY, 10036, US

(21) Appl. No.: 09/770,965

(22) Filed: Jan. 25, 2001

(30) Foreign Application Priority Data
Jul. 31, 2000 (JP) P2000-232468

(51) Int. Cl. G10L 19/00

(52) U.S. Cl. 704/500

(57) ABSTRACT

An apparatus and method for performing transform encoding, in which time domain samples can overlap one another by any desired percentage and can be added so that signals may be reproduced completely. In the apparatus and method, the linear/nonlinear prediction analysis section 3 receives an audio signal from the input terminal 2 and effectuates linear or nonlinear prediction on the audio signal, generating a prediction residual. The constancy inferring section 7 infers the constancy of the audio signal. The block-length determining section 8 determines the length of an MDCT block from the constancy of the input signal, which the section 7 has inferred. The MDCT section 5 receives M time domain samples supplied from the buffer 4 and having the prediction residual. The MDCT section 5 applies the block length determined by the section 8, performing MDCT transform on the time domain samples, thus generating MDCT coefficients. The quantization section 6 quantizes the MDCT coefficients.

### BACKGROUND OF THE INVENTION

The present invention relates to an apparatus and method for performing orthogonal transform on input time domain samples, while making them overlap one another. The invention also relates to an apparatus and method for performing inverse orthogonal transform on orthogonal transform coefficients generated by performing orthogonal transform on time domain samples, while making the samples overlap one another. Further, the invention relates to an apparatus and method for performing transform encoding, which utilize the orthogonal transform apparatus and method according to the invention. Still further, the invention relates to an apparatus and method for decoding signals, which employ the inverse orthogonal transform apparatus and method according to the invention.

Various digital encoding systems for encoding time domain samples, such as audio signals or image signals, have been proposed, which orthogonal transform such as fast Fourier transform (FFT), discrete-cosine transform (DCT) or modified discrete-cosine transform (MDCT) is carried out.

Of these orthogonal transforms, MDCT is recently found very popular for use in systems designed to perform orthogonal transform on audio signals, thereby to convert the signals to compressed codes. This is because MDCT effects the orthogonal transform, while making time domain samples overlap one another, and can attenuate the noise developing at the junction of data blocks, more effectively than DCT.

MDCT is defined by the following equation (1), and IMDCT, which is inverse to MDCT, is defined by the following equation (2).

$$\begin{matrix}y ( k ) = {\sum }_{m = 0}^{M - 1} x ( m ) h ( m ) cos \{ \frac{2 π}{M} ( k + \frac{1}{2} ) ( m + \frac{1}{2} + \frac{M}{4} ) \} ( 0 \leq k \leq \frac{M}{2} - 1 ) & ( 1 ) \\ \overline{x} ( m ) = \frac{2 f ( m )}{M} {\sum }_{k = 0}^{\frac{M}{2} - 1} y ( k ) cos \{ \frac{2 π}{M} ( k + \frac{1}{2} ) ( m + \frac{1}{2} + \frac{M}{4} ) \} ( 0 \leq m \leq M - 1 ) & ( 2 )\end{matrix}$$

In the equations (1) and (2), x is an input signal, y is an MDCT coefficient, x⁻ is an inverse MDCT output, M is a block length, h is a window function for forward transform, and f is a window function for inverse transform.

Substituting the equation (2) in the equation (1) results in the following equation (3):

$$\overline{x} ( m ) = \{ \begin{matrix}x ( m ) h ( m ) f ( m ) - x ( \frac{M}{2} - 1 - m ) h ( \frac{M}{2} - 1 - m ) f ( m ) & ( 0 \leq m \leq \frac{M}{2} - 1 ) \\ x ( m ) h ( m ) f ( m ) + x ( \frac{3 M}{2} - 1 - m ) h ( \frac{3 M}{2} - 1 - m ) f ( m ) & ( \frac{M}{2} \leq m \leq M - 1 )\end{matrix} \qquad ( 3 )$$

The equation (3) shows that the time-series signal x⁻(m) that is generated by first performing MDCT and then IMDCT contains an aliasing component. The aliasing component can be completely eliminated if appropriate window functions h(m) and f(m) are selected and the time-series signals are made to overlap one another by 50%.

FIG. 1 is a diagram representing the algorithm of MDCT and the algorithm of IMDCT. More correctly, FIG. 1 shows how MDCT and IMDCT are effected on adjacent (j−1)th block and j-th block in the time domain sample x(m). The (j−1)th block and the j-th block have the same length M and overlap each other by 50%. A window represented by the window function h(m) is applied to the (j−1)th block and the j-th block, thus achieving forward linear transform. MDCT coefficients for M/2 points are thereby obtained. This is the process of MDCT transform. In IMDCT, the MDCT coefficients are subjected to inverse linear transform, a window represented by the window function f(m) is applied to the (j−1)th block and the j-th block, and the blocks overlapping are added together, thereby generating an M/2 number of time domain samples x⁻(m).

In audio-signal encoding systems, particularly a system that is designed to perform transform encoding, the resultant sound quality depends on the length of the blocks that will be subjected to orthogonal transform. Generally, the higher frequency resolution is provided, if the block length of orthogonal transform is long, the lower frequency resolution is provided, if the block length of orthogonal transform is short. It is therefore desired that the blocks be as long as possible to enhance the efficiency of orthogonal transform, if the input signals fluctuate with time but a little. If the input signals much fluctuate with time, it is desired that the blocks be as short as possible. The input signals may represent attack music and may therefore greatly fluctuate with time. In this instance, no sufficient time resolution will be attained if the input signals are subjected to MDCT in the form of excessively long blocks. Consequently, the sound reproduced from the blocks contains pre-echo or post-echo and inevitably has poor quality. In view of this, the length of blocks may be changed in accordance with the characteristic of the input signals, thereby to accomplish high-efficiency signal encoding. In fact, audio-signal encoding systems employing this method of changing the block length have been proposed.

To change the block length on the basis of the equations (1) and (2) given above, however, the aliasing generated in a time region must be canceled. The time-domain samples x⁻(m) could not otherwise be perfectly identical to the time-domain samples x(m). In the method disclosed in Takashi Mochizuki, Perfect Reconstruction Conditions for Adaptive Blocksize MDCT, IEICE Trans. fundamentals, Vol. E77-A, No. 5, pp. 894-899, May 1994, a window is selected that cancels aliasing, thus effecting MDCT and IMDCT of the equations (1) and (2) on locks that have different lengths. FIG. 2 explains how the method disclosed in the thesis changes block length M₁ to block length M₂, where M₁<M₂. As shown in FIG. 2, (j−2)th frame and (j−1)th frame have block length M₁, whereas j-th frame has block length M₂.

In the case illustrated in FIG. 2, the fame j, whose block length will change, has a coefficient of 0 for the first half of its window, i.e., (M₂-M₁)/4. The effective range of the window is therefore 3(M₂-M₁))/4, which is shorter than the MDCT block length M₂. This means that MDCT is performed on the input samples, 3(M₂-M₁))/4, in the form of a block that is longer than necessary. The efficiency of MDCT is inevitably low. If the input samples are process prior to the MDCT in blocks of time region, they will change in phase. Inevitably, it will be difficult to effect MDCT on the input samples thus pre-processed.

The j-th frame may have its block length changed from M₁ to M₂, as is illustrated in FIG. 3. In this case, the effective range of the window will be equal to the MDCT block length if the j-th frame overlaps the preceding (j−1)th frame and the following (j+1)th frame by the same number of samples. If the block length M₂ is an integral multiple of the block length M₁, the input samples will not change in phase despite the change in block length. Thus, it is easy to perform MDCT on the input samples thus pre-processed.

However, the MDCT defined by the equations (1) and (2) cannot cancel the aliasing component of time-series signal x⁻(m) that has been generated by IMDCT, unless the frame being processed is made to overlap the preceding and following frames by 50%. It follows that the time-domain samples cannot be restored if the j-th frame overlaps the preceding and following frames in such a manner as is shown in FIG. 3.

### BRIEF SUMMARY OF THE INVENTION

The present invention has been made in consideration of the foregoing. An object of the invention is to provide an apparatus and method for performing orthogonal transform on input time domain samples, while making them overlap one another by any desired percentage. A second object of the invention is to provide an apparatus and method for performing inverse orthogonal transform on orthogonal transform coefficients generated by the orthogonal transform apparatus or method.

A third object of this invention is to provide an apparatus and method for performing transform encoding, in which time domain samples can overlap one another by any desired percentage and can be added so that signals may be reproduced completely. A fourth object of the invention is to provide an apparatus and method for decoding signals.

To achieve the first object, an orthogonal transform apparatus according to the invention performs orthogonal transform on input time domain samples, while making the input time domain samples overlap one another. The apparatus is characterized in that a boundary of occurring aliasing during inverse orthogonal transform is changed in the range of 0=<á<M, where a is the boundary, where M is the number of the time domain samples subjected to the orthogonal transform.

To accomplish the first object, too an orthogonal transform method according to the invention performs orthogonal transform on input time domain samples, while making the input time domain samples overlap one another. In the method, a boundary of occurring aliasing during inverse orthogonal transform is changed in the range of 0=<á<M, where a is the boundary, where M is the number of the time domain samples subjected to the orthogonal transform.

To attain the second object mentioned above, an inverse orthogonal transform apparatus according to this invention performs inverse orthogonal transform on orthogonal transform coefficients obtained by effecting orthogonal transform on time domain samples while making the time domain samples overlap one another. The orthogonal transform coefficients have been generated by changing a boundary a of occurring aliasing during inverse orthogonal transform in the range of 0=<á<M, where á is the boundary. Note that M is the number of the time domain samples subjected to the orthogonal transform.

To achieve the second object, too, an inverse orthogonal transform method according to the present invention performs inverse orthogonal transform on orthogonal transform coefficients obtained by effecting orthogonal transform on time domain samples while making the time domain samples overlap one another. The orthogonal transform coefficients have been generated by changing a boundary a of occurring aliasing during inverse orthogonal transform in the range of 0=<á<M, where á is the boundary. Note that M is the number of the time domain samples subjected to the orthogonal transform.

In order to attain the third object mentioned above, a transform encoding apparatus according to the invention performs orthogonal transform on an input signal, thereby to compress and encode the input signal. This apparatus comprises: prediction analysis means for fetching the input signal, in units of a prescribed number of samples, and effecting prediction analysis on the samples and generating prediction residuals; characteristic-determining means for determining characteristic of each sample of the input signal; block-length determining means for determining a block length for use in the orthogonal transform, from the characteristic of the sample, which has been determined by the characteristic-determining means; orthogonal transform means for determining, from the block length determined by the block-length determining means, a boundary of occurring aliasing during inverse orthogonal transform in the range of 0=<á<M, where 6 is the boundary, and for performing orthogonal transform on the M time domain samples, while causing the prediction residuals generated by the prediction analysis means and used as M time domain samples to overlap one another, thereby generating orthogonal transform coefficients; and quantization means for quantizing the orthogonal transform coefficients generated by the orthogonal transform means, thereby generating quantized data.

With this apparatus it is possible to change the block length for orthogonal transform in accordance with the characteristic of the input signal. Transform encoding, such as quantization of orthogonal transform coefficients, can therefore be accomplished easily.

To accomplish the third object, too, a transform encoding method according to this invention performs orthogonal transform on an input signal, thereby to compress and encode the input signal. The method comprises the steps of: fetching the input signal, in units of a prescribed number of samples, and effecting prediction analysis on the samples and generating prediction residuals; determining characteristic of each sample of the input signal; determining a block length for use in the orthogonal transform, from the characteristic of the sample, which has been determined in the step of determining characteristic; determining, from the block length determined in the step of determining a block-length, a boundary of occurring aliasing during inverse orthogonal transform in the range of 0=<á<M, where a is the boundary, and for performing orthogonal transform on the M time domain samples, while causing the prediction residuals generated by the prediction analysis means and used as M time domain samples to overlap one another, thereby generating orthogonal transform coefficients; and quantizing the orthogonal transform coefficients generated in the step of performing orthogonal transform, thereby generating quantized data.

To achieve the fourth object set forth above, a decoding apparatus according to the invention decodes quantized data that has been generated by determining, from the block length based on the characteristic of an input signal, a boundary of occurring aliasing during inverse orthogonal transform in the range of 0=<á<M, where a is the boundary, by performing orthogonal transform on M time domain samples, while causing the M input time domain samples to overlap one another, thereby generating orthogonal transform coefficients, and by quantizing the orthogonal transform coefficients thus generated. The apparatus comprises: inverse quantization means for performing inverse quantization on the quantized data, thereby generating orthogonal transform coefficients; and inverse orthogonal transform means for performing inverse orthogonal transform on the orthogonal transform coefficients generated by the inverse quantization means, by applying the block length determined from the characteristic of the input signal.

To accomplish the fourth object, too, a decoding method according to the invention decodes quantized data generated by determining, from the block length based on the characteristic of an input signal, a boundary of occurring aliasing during inverse orthogonal transform in the range of 0=<á<M, where a is the boundary, by performing orthogonal transform on M time domain samples, while causing the M input time domain samples to overlap one another, thereby generating orthogonal transform coefficients, and by quantizing the orthogonal transform coefficients thus generated. The method comprises the steps of: performing inverse quantization on the quantized data, thereby generating orthogonal transform coefficients; and performing inverse orthogonal transform on the orthogonal transform coefficients generated in the step of performing the inverse quantization, by applying the block length determined from the characteristic of the input signal.

In the orthogonal transform apparatus and method, both according to the present invention, time domain samples can overlap one another by any desired percentage, thereby generating orthogonal transform coefficients.

The inverse orthogonal transform apparatus and method, according to this invention, can effect inverse orthogonal transform on the orthogonal transform coefficients generated by the orthogonal transform apparatus and method described above.

In the transform encoding apparatus and method, according to the present invention, time domain samples can overlap one another by any desired percentage and can be added so that signals may be reproduced completely.

The decoding apparatus and method, both according to the invention, can decode data encoded by the transform encoding apparatus and method described above.

### BRIEF DESCRIPTION OF THE SEVERAL VIEWS OF THE DRAWING

FIG. 1 is a diagram explaining an MDCT algorithm;

FIG. 2 is a diagram explaining a conventional method of changing the length of a block;

FIG. 3 is a diagram explaining how the length of a block is changed if the block does not have a coefficient of 0 for its window;

FIG. 4 is a block diagram of an encoder that is a first embodiment of the present invention;

FIG. 5 is a diagram illustrating a sequence of samples of an audio signal;

FIG. 6 is a block diagram of a decoder that is a second embodiment of this invention;

FIG. 7 is a diagram explaining a conventional method of changing the length of a block; and

FIG. 8 is a diagram explaining a method of changing the length of a block in the present invention.

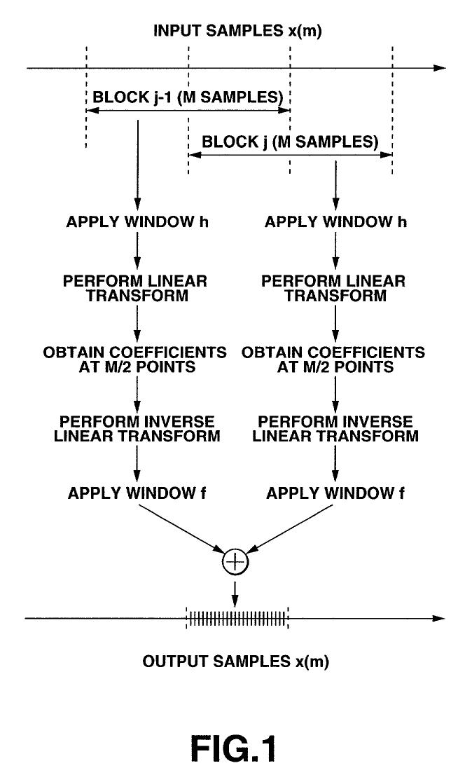

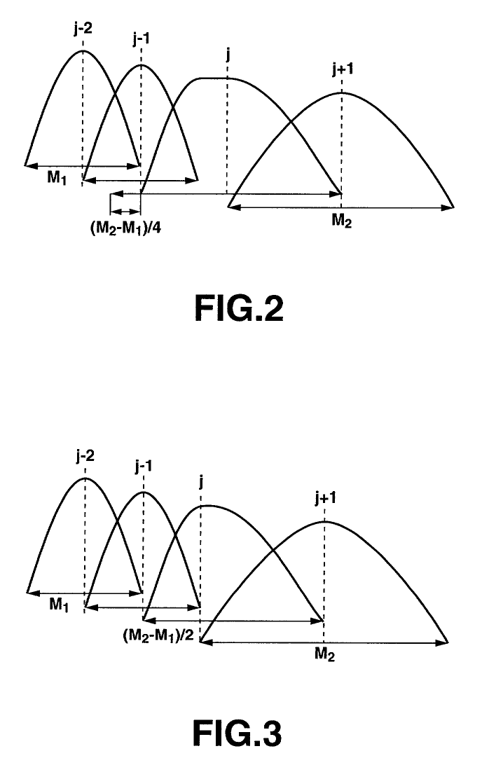

### DETAILED DESCRIPTION OF THE INVENTION

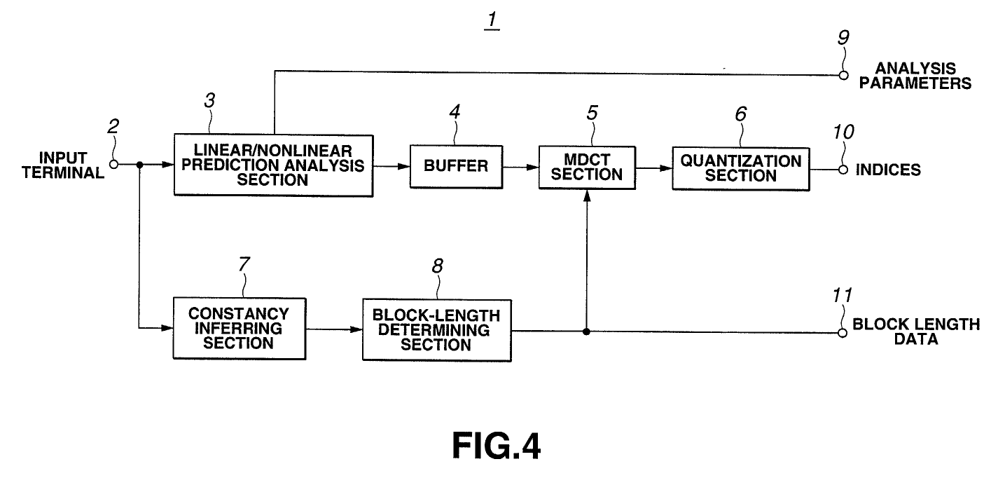

Embodiments of the present invention will be described, with reference to the accompanying drawings. FIG. 4 illustrates an encoder 1, which is a first embodiment of the invention. The encoder 1 has an input terminal 2 and an MDCT section 5. The input terminal 2 receives an audio signal that has been sampled at frequency of 16 KHz. The MDCT section 5, which will be later described in detail, compresses and encodes the audio signal.

As shown in FIG. 4, the encoder 1 comprises a linear/nonlinear prediction analysis section 3, a constancy inferring section 7, a block-length determining section 8, and a quantization section 6, in addition to the input terminal 2 and an MDCT section 5. The linear/nonlinear prediction analysis section 3 effects linear/nonlinear prediction analysis on the audio signal supplied from the input terminal 2 and generates a prediction residual. The constancy inferring section 7 infers the constancy of the audio signal. The block-length determining section 8 determines the length of a block to be subjected to MDCT, from the constancy of the audio signal, which the section 7 has inferred. The MDCT section 5 executes MDCT on the M time domain samples of the prediction residual, which have been input via the buffer 4 and which form a sequence having the length the section 8 has determined. Thus, the MDCT section 5 generates MDCT coefficients. The quantization section 6 quantizes the MDCT coefficients.

The linear/nonlinear prediction analysis section 3 fetches, for example, 1024 samples from the audio signal. The section 3 performs either linear prediction or nonlinear prediction on these samples, generating a prediction residual. The prediction residual is output to a buffer 4 that is a component of the encoder 1. The linear/nonlinear prediction analysis section 3 generates analysis parameters, too. The analysis parameters are output from an output terminal 9 that is another component of the encoder 1. More specifically, the section 3 carries out 16th-order LPC analysis on the audio signal, generating an LPC coefficient. The LPC coefficient is converted to an LSP, which is quantized and subjected to intra-frame interpolation. The LSP thus interpolated is applied, whereby an LPC residual. Further, the section 3 obtains the pitch lag most appropriate in the LSP difference, and calculates the optimal gain for the pitch lag at a ±1 point, thus effecting vector quantization on the pitch gain. The pitch gain thus vector-quantized is applied, providing a pitch inverse filter. The pitch inverse filter is used, generating a pitch difference.

As described above, the constancy inferring section 7 infers the constancy of the audio signal. If the MDCT block is too long, no transient signals can attain a sufficient time resolution. Consequently, the sound reproduced from such an audio signal contains pre-echo or post-echo and, hence, has but poor quality. Thus, it is desired that the MDCT block be short for an audio signal of this type. On the other hand, any quasi-constant signal that changes with time only a little may have many bits if the MDCT block is made long, thus reducing the number of bits for normalization and analysis parameters. In the encoder 1 shown in FIG. 4, the block length is changed, from a long one to a short one, and vice versa, in accordance with the characteristic of the input signal. The characteristic of the input signal is determined by the constancy inferring section 7. The section 7 finds changes of frame power and LSP from the preceding frame. The section 7 then sets a flag to any frame if above changes exceed predetermined threshold value. If no flags are set to several frames preceding the present frame or to several flags following the present frame, the section 7 determines that the input signal is a quasi-constant signal that changes with time only a little.

The block-length determining section 8 determines that the MDCT block should be long if the section 7 has inferred that the audio signal has high constancy. If the audio signal is a transient signal, the section 8 determines that the MDCT block should be short. The section 8 generates information representing the block length thus determined. The data is output from an output terminal 11.

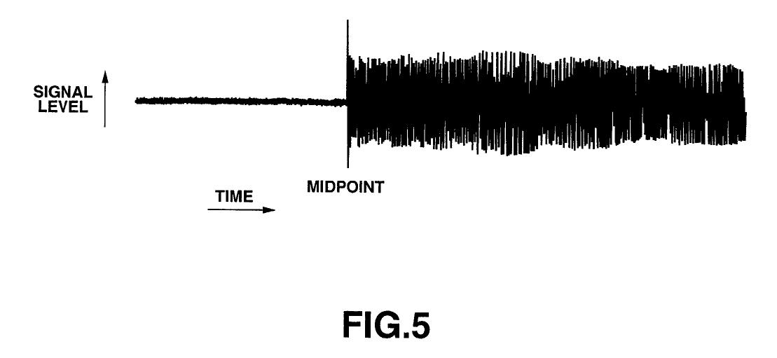

FIG. 5 shows a sequence of samples of an audio signal. As seen from FIG. 5, this audio signal fluctuates at a position near the midpoint in the sample sequence. When this signal is input to the encoder 1 of FIG. 4, it is desired that a short block length be selected for the samples where the signal fluctuates very much.

The MDCT section 5 receives the data from the block-length determining section 8. From the block length represented by the data the section 5 determines a boundary of occurring aliasing during IMDCT. The position a falls within the range of 0<á<M. The section 5 then performs MDCT on the M time domain samples, while making the M time domain samples (i.e., the prediction residual output from the linear/nonlinear prediction analysis section 3) overlap one another. The MDCT section 5 generates MDCT coefficients.

The quantization section 6 quantizes the MDCT coefficients, finding the indices of the MDCT coefficients. The indices are output from an output terminal 10. How the section 6 quantizes the MDCT coefficients will be described. The prediction residual output from the linear/nonlinear prediction analysis section 3 may be the pitch difference mentioned above. If this is the case, the quantization section 6 first normalizes the MDCT coefficients and then quantizes them, by using three kinds of quantization units, i.e., 2-dimensional 8-bit unit, 4-dimensional 8-bit unit, and 8-dimensional 8-bit unit. Bit allocation is determined by the weights calculated from only the parameters applied to analysis a quantization. Therefore, parameters such as position data items are not necessary as in the method wherein MDCT coefficients are quantized after bit allocation is effected in the best way for each MDCT coefficient. Thus, more bits can be allocated to the quantization of MDCT coefficients.

The operation of the encoder 1 described above will be explained. The input terminal 2 receives an audio signal that has been sampled at the frequency of 16 KHz. The linear/nonlinear prediction analysis section 3 fetched 1024 samples from the audio signal. The section 3 effectuates linear or nonlinear prediction on these samples, generating a prediction residual. The prediction residual is output to the buffer 4. Meanwhile, the audio signal is supplied from the input terminal 2 to the constancy inferring section 7. The section 7 infers the constancy of the audio signal. The block-length determining section 8 determines whether the MDCT block should have a length of 1024 samples or a length of 2048 samples, from the constancy of the input signal, which the section 7 has inferred. Hence, the length of 1024 samples is selected for that part of the signal which needs to have high time resolution; the length of 2048 samples is selected for that part of the signal which changes only a little and is thus considered to be relatively constant. Thereafter, the MDCT section 5 receives some of the samples from the buffer 4 in accordance with the block length the section 8 has determined. The section 5 carries out MDCT on these samples, generating MDCT coefficients. The MDCT coefficients are supplied to the quantization section 6. The section 6 quantizes the MDCT coefficients, the indices of which are output from the output terminal 10, while the block length data is output from the output terminal 11.

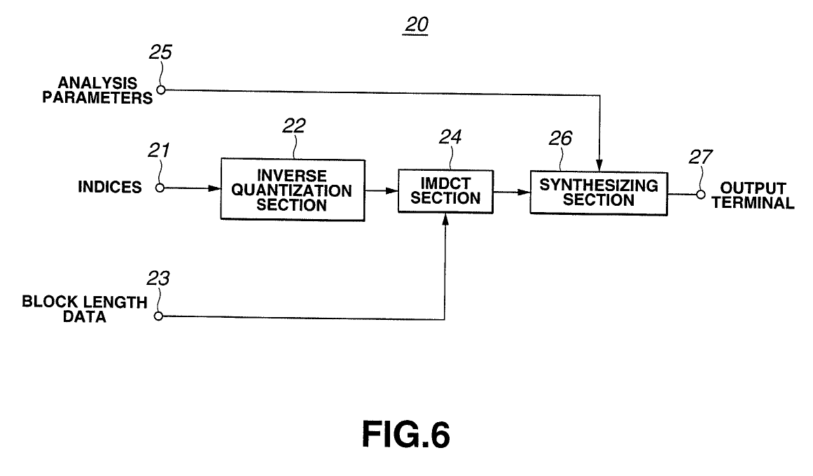

FIG. 6 shows a decoder 20 that is the second embodiment of this invention. The decoder 20 is desired to receive the analysis parameters, indices and block length data, all output from the encoder 1 illustrated in FIG. 4 and to reproduce an audio signal from these input data items.

The decoder 20 comprises an input terminal 21, an inverse quantization section 22, an input terminal 23, an IMDCT section 24, an input terminal 25, a synthesizing section 26, and an output terminal 27. The input terminal 21 receives the indices output from the encoder 1. The inverse quantization section 22 effects inverse quantization on the indices supplied from the input terminal 21. The section 22 generates MDCT coefficients from the indices. The MDCT coefficients are input to the IMDCT section 24. The input terminal 23 receives the block length data from the encoder 1. The IMDCT section 24 performs inverse MDCT on the MDCT coefficients in accordance with the block length data, thus generating time-series parameters. The time-series parameters are input to the synthesizing section 26. The input terminal 25 receives the analysis parameters supplied from the encoder 1. The synthesizing section 26 synthesizes the analysis parameters and the time-series parameters, reproducing an audio signal.

How the decoder 20 operates will be described in brief. The inverse quantization section 22 receives the indices supplied from the encoder 1 to the input terminal 21. The section 22 performs inverse quantization on the indices, generating MDCT coefficients. The MDCT coefficients are input to the IMDCT section 24. Meanwhile, the input terminal 23 receives the block length data from the encoder 1. The block length data is input to the IMDCT section 24. The IMDCT section 24 performs inverse MDCT on the MDCT coefficients in accordance with the block length data, thus generating time-series parameters. The time-series parameters are input to the synthesizing section 26. In the meantime, the input terminal 25 receives the analysis parameters supplied from the encoder 1. The analysis parameters are input to the synthesizing section 26. The section 26 synthesizes the analysis parameters and the time-series parameters, thereby reproducing an audio signal.

The encoder 1 of FIG. 4 and the decoder 20 of FIG. 6, which are the first and second embodiments of this invention, have been described. An orthogonal transform apparatus and an inverse orthogonal transform apparatus, both according to the present invention, will now be described.

The orthogonal transform apparatus of the invention may be used as the MDCT section 5 incorporated in the encoder 1 shown in FIG. 4. The inverse orthogonal transform apparatus of this invention may be used as the IMDCT section 24 provided in the decoder 20 illustrated in FIG. 6. The MDCT section 5 has been designed to solve the problem with the conventional MDCT apparatus. The conventional MDCT apparatus which effectuates MDCT defined by the equations (1) and (2), cannot cancel the aliasing in time domain samples x⁻(m) that have been obtained by means of IMDCT, because it overlaps the preceding an following frames by 50%. Consequently, the conventional MDCT apparatus cannot restore the time domain samples because the j-th frame overlaps the preceding (j−1)th frame and the following (j−1)th frame as is illustrated in FIG. 3.

To restore the time domain samples completely even if the block length is changed as is depicted in FIG. 3, the MDCT section 5 performs MDCT defined by the following equation (4), and the IMDCT section 24 executes IMDCT defined by the following equation (5).

$$\begin{matrix}y ( k ) = {\sum }_{m = 0}^{M - 1} x ( m ) h ( m ) cos \{ \frac{2 π}{M} ( k + \frac{1}{2} ) ( m + \frac{1}{2} + \frac{α}{2} ) \} ( 0 \leq k \leq \frac{M}{2} - 1 ) & ( 4 ) \\ \overline{x} ( m ) = \frac{2 f ( m )}{M} {\sum }_{k = 0}^{\frac{M}{2} - 1} y ( k ) cos \{ \frac{2 π}{M} ( k + \frac{1}{2} ) ( m + \frac{1}{2} + \frac{α}{2} ) \} ( 0 \leq m \leq M - 1 ) & ( 5 )\end{matrix}$$

In the equations (4) and (5), x is an input signal, y is an MDCT coefficient, x⁻ is an inverse MDCT output, M is a block length, h is a window function for forward transform, f is a window function for inverse transform, and a is the boundary of occurring aliasing and a falls within the range of 0=<á<M.

The parameter a in the equations (4) and (5) determines the sampling position where aliasing takes place in the time domain samples x⁻(m) obtained by means of IMDCT. If á=M/2, the MDCT will be identical to the MDCT defined by the equations (1) and (2).

Substituting the equation (5) in the equation (4) results in the following equation (6):

$$\overline{x} ( m ) = \frac{2 f ( m )}{M} {\sum }_{k = 0}^{\frac{M}{2} - 1} [ {\sum }_{r = 0}^{M - 1} x ( r ) h ( r ) cos \{ \frac{2 π}{M} ( k + \frac{1}{2} ) ( r + \frac{1}{2} + \frac{α}{2} ) \} ] \cdot cos \{ \frac{2 π}{M} ( k + \frac{1}{2} ) ( m + \frac{1}{2} + \frac{α}{2} ) \} = \frac{2 f ( m )}{M} {\sum }_{r = 0}^{M - 1} x ( r ) h ( r ) {\sum }_{k = 0}^{\frac{M}{2} - 1} cos \{ \frac{2 π}{M} ( k + \frac{1}{2} ) ( r + \frac{1}{2} + \frac{α}{2} ) \} \cdot cos \{ \frac{2 π}{M} ( k + \frac{1}{2} ) ( m + \frac{1}{2} + \frac{α}{2} ) \} = \frac{f ( m )}{M} {\sum }_{r = 0}^{M - 1} x ( r ) h ( r ) [ {\sum }_{k = 0}^{\frac{M}{2} - 1} cos \{ \frac{2 π}{M} ( k + \frac{1}{2} ) ( r - m ) \} + {\sum }_{k = 0}^{\frac{M}{2} - 1} cos \{ \frac{2 π}{M} ( k + \frac{1}{2} ) ( r + m + 1 + α ) \} ] \qquad ( 6 )$$

î(1) is defined as follows:

$$ξ ( l ) = {\sum }_{k = 0}^{\frac{M}{2} - 1} cos \{ \frac{2 π}{M} ( k + \frac{1}{2} ) l \}$$

Rewriting the equation (6) by using î(1) results in the following equation (7):

$$\overline{x} ( m ) = \frac{f ( m )}{M} {\sum }_{r = 0}^{M - 1} x ( r ) h ( r ) \{ ξ ( r - m ) + ξ ( r + m + 1 + α ) \} \qquad ( 7 )$$

Here î(1) is expressed by the following equation (8):

$$ξ ( l ) = \{ \begin{matrix}\frac{M}{2} & if l = ξ M , ξ \text{:} even number \\ - \frac{M}{2} & if l = ξ M , ξ \text{:} odd number \\ 0 & otherwise\end{matrix}$$

In the equation (6), 0≦r<M and 0≦m <M. Hence, the equation (6) can become simple, having only the following three terms:

$$\{ \begin{matrix}r - m & = 0 \\ r + m + 1 + α & = M \\ r + m + 1 + α & = 2 M\end{matrix}$$

Therefore, we can obtain the following equation (9):

$$\overline{x} = \{ \begin{matrix}x ( m ) h ( m ) f ( m ) - x ( M - α - 1 - m ) h ( M - α - 1 - m ) f ( m ) & ( 0 \leq m \leq α - 1 ) \\ x ( m ) h ( m ) f ( m ) + x ( 2 M - α - 1 - m ) h ( 2 M - α - 1 - m ) f ( m ) & ( α \leq m \leq M - 1 )\end{matrix} \qquad ( 9 )$$

The second term in each right side of the equation (9) is an aliasing component. Two aliasing components of the opposite polarities take place right before and after the á-th sample, respectively. Thus, the aliasing can be canceled by appropriate windows f(m) and h(m) are selected and applied, thereby aligning the aliasing component of the sample immediately preceding the a-th sample with the aliasing component of the sample immediately following the a-th sample.

The conditions for restoring the samples will be explained. There are three conditions required to cancel aliasing, thereby to restore the samples perfectly, are given by the following equations (10), (11) and (12):

aⱼ=Mⱼ₋₁−aⱼ₋₁ (10)

hⱼ(aⱼ−m)fⱼ(m)=hⱼ₋₁(Mⱼ₋₁−m)fⱼ₋₁(aⱼ₋₁+m)(0≦m<aⱼ) (11)

hⱼ(m)fⱼ(m)+hⱼ₋₁(aⱼ₋₁+m)fⱼ₋₁(aⱼ₋₁+m)=1(0≦m<aⱼ) (12)

In the equations (10), (11) and (12), Mj is the block length for frame j, áj is the aliasing border, hj(m) is a window for forward transform, fj(m) is a window for inverse transform.

How the MDCT section 5 changes the block length will be described, on the assumption that the window h(m) for forward transform and the window f(m) for inverse transform are identical to each other, for the sake of simplicity. Assume that normal MDCT (á=M/2) is effected on all blocks, except those block for which the length is changed. Further assume that the windows are symmetrical, that is, the windows are defined as follows when 0≦m<M:

$$( \begin{matrix}h ( m ) & = f ( m ) \\ h ( m ) & = h ( M - m )\end{matrix}$$

If the following equation is established, the condition for restoring the samples will be satisfied.

h(m)²+h(M−m)²=1

In these conditions, the block length is changed from M₁ to M_{2, where M}₁<M₂.

In view of the condition defined by the equation (10), the aliasing border a at which the block length is changed for the j-th frame must satisfy the following equation (13).

$$α = \frac{{M}_{1}}{2} \qquad ( 13 )$$

Let us use a window hₛ(m) for a frame having the block length M₁ and a window h₁(m) for a frame having the block length M₂. In view of the condition defined by the equation (11), the window h₁(m)for the j-th frame must satisfy the following equation (14).

$${h}_{t} ( m ) = \{ \begin{matrix}{h}_{s} ( m ) & ( 0 \leq m < \frac{{M}_{1}}{2} ) \\ {h}_{l} ( m + \frac{{M}_{2}}{2} ) & ( \frac{{M}_{1}}{2} \leq m < \frac{( {M}_{1} + {M}_{2} )}{2}\end{matrix} \qquad ( 14 )$$

If the conditions of the equations (13) and (14) are satisfied, the condition of the equation (12) will, of course, be satisfied. It follows that the time domain samples constituting any block whose length is changed can be restored perfectly.

A fast algorithm for MDCT is proposed in Masahiro Iwadare, Takao Nishiya and Akihiko Sugiyama, Study on MDCT System, and Fast Algorithm, Shingaku Technical Report, Vol. CAS90-9 DSP90-13, pp. 49-54, 1990. This algorithm may be utilized in order to achieve MDCT defined by the equations (4) and (5) at high speed. The sequence of performing MDCT by using the algorithm will be described below.

First, the forward transform will be explained. Let us define xh(m) and x₂(m) as follows:

$$xh ( m ) = x ( m ) h ( m ) \\ \{ \begin{matrix}{x}_{2} ( m ) = - xh ( m + M - \frac{α}{2} ) & ( 0 \leq m < \frac{α}{2} ) \\ {x}_{2} ( m ) = xh ( m - \frac{α}{2} ) & ( \frac{α}{2} \leq m < M )\end{matrix} \qquad ( 15 )$$

The operation defined by the equation (15) is equivalent to the equation (11) described in Study on MDCT System, and Fast Algorithm. The equation (15) is identical to the equation (11) if á=M/2. We may use x₂(m), thus rewriting the equation (4) to the following equation (16):

$$y ( k ) = {\sum }_{m = 0}^{M - 1} {x}_{2} ( m ) cos \{ \frac{2 π}{M} ( k + \frac{1}{2} ) ( m + \frac{1}{2} ) \} ( 0 \leq k \leq \frac{M}{2} - 1 ) \qquad ( 16 )$$

The equation (16) is identical to the equation (12) described in Study on MDCT System, and Fast Algorithm. In the method disclosed in the thesis, the equation (12) is modified and applied, thus realizing a high-speed operation. The operation of the equation (15) is carried out in place of the operation of the equation (11) described in the thesis, and the operations identical to those specified in the thesis are then performed. Thus, the fast algorithm proposed in Study on MDCT System, and Fast Algorithm can be applied in order perform the operation of the equation (4). The MDCT is effectuated in the following sequence.

First, the input signal xh(m) to which a window for forward transform has been applied is rearranged as follows, in accordance with the equation (16) described above.

Next, x₃(m) is generated from x₂(m) in accordance with the following equation (17).

$${x}_{s} ( m ) = {x}_{2} ( 2 m ) - {x}_{2} ( M - 1 - 2 m ) ( 0 \leq < \frac{M}{2} ) \qquad ( 17 )$$

Then, x₃(m) is multiplied by exp (−j·(2 δm/M)), generating a complex signal z₁(m) that is given as follows:

$${z}_{1} ( m ) = {x}_{3} ( m ) exp ( - j 2 π \frac{m}{M} ) \qquad ( 18 )$$

Fast Fourier transform (FFT) is executed on z₁(m) at M/2 points, obtaining z₂(k) expressed by the following equation (19):

$${z}_{2} ( k ) = {\sum }_{m = 0}^{M / 2 - 1} {z}_{1} ( m ) exp ( - j 2 π k \frac{m}{( M / 2 )} ) \qquad ( 19 )$$

Finally, MDCT coefficients are extracted from the results of the FFT, in accordance with the equation (20) presented below:

$$y ( k ) = Re ( {z}_{2} ( k ) exp ( - j 2 \frac{2 π ( k + 1 / 2 )}{2 M} ) \qquad ( 20 )$$

The fast algorithm disclosed in the thesis Study on MDCT System, and Fast Algorithm can be applied to the inverse transform, in the same manner as in the forward transform. In the inverse transform, however, the last time domain sample must be changed in terms of polarity and must be rearranged.

That is, the coefficients are rearranged in such a way as indicated by the following equation (21):

$$\{ \begin{matrix}{y}_{2} ( k ) = y ( 2 k ) & ( 0 \leq k < \frac{M}{4} ) \\ {y}_{2} ( k ) = - y ( M - 1 - 2 k ) & ( \frac{M}{4} \leq k < \frac{M}{2} )\end{matrix} \qquad ( 21 )$$

Then, y₂(k) is multiplied by exp (−j·(2 δk/M)), generating a complex signal z₁(m) that is given as follows:

$${Z}_{1} ( k ) = {y}_{2} ( k ) exp ( j 2 π \frac{k}{M} ) \qquad ( 22 )$$

Next, inverse FFT is performed on z₁(k) at M/2 points, thus obtaining z₂(m) expressed by the following equation (23):

$${Z}_{2} ( m ) = \frac{1}{M / 2} {\sum }_{k = 0}^{M / 2 - 1} {Z}_{1} ( k ) exp ( j \frac{2 π mk}{( M / 2 )} \qquad ( 23 )$$

Thereafter, x0⁻(m) is extracted from the results of the FFT, in accordance with the equation (24) presented below:

$${\overline{x}}_{0} ( m ) = Re ( 2 {Z}_{2} ( m ) exp ( j \frac{2 π ( m + 1 / 2 )}{2 M} ) \qquad ( 24 )$$

Finally, x0⁻(m) is changed in terms of polarity and is rearranged, obtaining the result x-(m) of IMDCT, which is defined by the following equation (25).

$$\overline{x} ( m ) = \{ \begin{matrix}f ( n ) {\overline{x}}_{0} ( n + \frac{α}{2} ) & 0 \leq m < \frac{M - α}{2} \\ - f ( n ) {\overline{x}}_{0} ( M - \frac{α}{2} - 1 - n ) & \frac{M - α}{2} \leq m < M - \frac{α}{2} \\ - f ( n ) {\overline{x}}_{0} ( n - ( M - \frac{α}{2} ) ) & M - \frac{α}{2} \leq m < M\end{matrix} \qquad ( 25 )$$

The number of input points will be explained. When the block length M is changed for a frame by the method according to this invention, it may not become a power of two for the frame even if the frame that will be subjected to the conventional MDCT. This may happen in the case where the (j−1)th and (j+1)th frames have the following lengths and the aliasing border is given as follows.

$$( j - 1 ) th frame {M}_{j - 1} = {2}^{a} , {α}_{j - 1} = \frac{{M}_{j - 1}}{2}$$

$$( j + 1 ) th frame {M}_{j + 1} = {2}^{b} , {α}_{j + 1} = \frac{{M}_{j + 1}}{2}$$

In this case, the j-th frame has a block length Mⱼ that is given as follows, in consideration of the condition of the equation (10).

$$\begin{matrix}{M}_{j} = {α}_{j} + {α}_{j + 1} \\ = {M}_{j - 1} - α j - 1 + α j + 1 \\ = \frac{{M}_{j - 1} + {M}_{j + 1}}{2} \\ = {2}^{a - 1} + {2}^{b - 1}\end{matrix} \qquad ( 26 )$$

If a<b, Mⱼ, will be expressed as follows:

Mⱼ=(1+2^{b-a})2^{a-1}

Obviously, the block length Mj of the j-th frame is not a power of two. The j-th frame must therefore be subjected to FFT of the equation (19) or IFFT of the equation (23), in which no power of two involves. In most FFT and IFFT, the number of points is a power of two. Otherwise, the number of points cannot be calculated. Any FFT apparatus in which the number of points is not a power of two cannot perform the operation described above.

The assignee of the present application has proposed a fast Fourier transform method and a fast inverse Fourier transform method, which find a number of points, P×2^{Q} where P is an odd number and Q is an integer, in a Japanese patent application, JP2000-232469. If these methods are applied, it will be possible to perform the operation described above, at high speeds.

In the fast Fourier transform method, the input data is complex-number data representing the P×2^{Q} points. Fast Fourier transform is effected on this input data, thereby generating complex-number data for P×2^{Q} points. More specifically, N points forming a column x are divided by the odd number Q, forming groups each consisting of N/Q points. P-point data is acquired for each group of N/Q points and subjected to discrete Fourier transform, thereby obtaining a Q-point discrete Fourier transform coefficient. The transform coefficient is multiplied by a twist coefficient. The product of the multiplication is fed back to the above-mentioned column x. Finally, fast Fourier transform is executed on 2^{Q} points in each of the P regions.

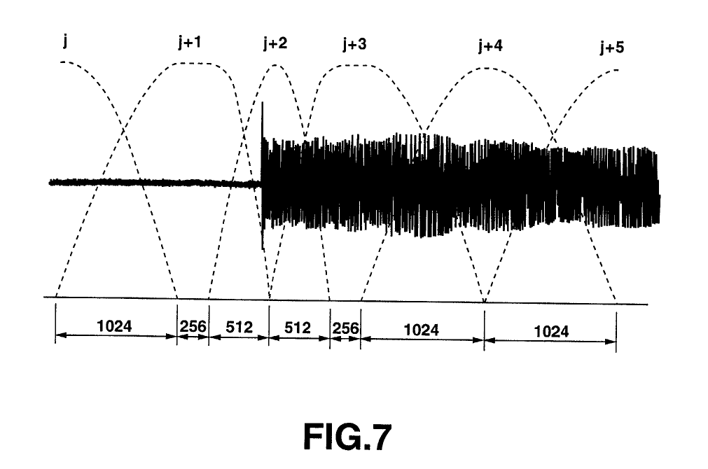

FIG. 7 is a diagram that explains a conventional method of changing the block length. More precisely, FIG. 7 illustrates how frames are fetched from a block of the input signal. A short block length is selected for the (j+2)th frame that follows the (j+1)th frame, whereas a long block length is selected from the (j+4)th frame that follows the (j+3)th frame. As is clearly seen from FIG. 7, the (j+1)th frame and the (j+2)th frame have a phase difference of 256 samples. Similarly, the (j+2)th frame and the (j+3)th frame have a phase difference of 256 samples. In the process prior to the MDCT (i.e., linear/nonlinear prediction), phase differences should be taken into account for the (j+2)th frame and the (j+4)th frame. Therefore, a special process, such as changing of the block length, must be carried out on the (j+2)th and (j+4)th frames.

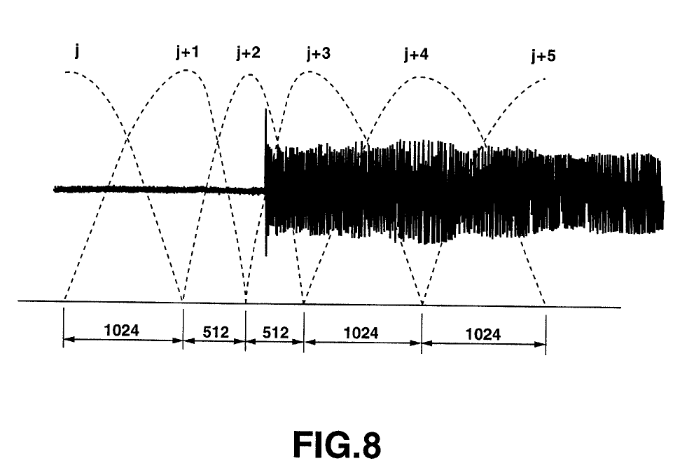

FIG. 8 is a diagram explaining how windows should be applied to MDCT blocks in the encoder 1 when the encoder 1 receives the signal of FIG. 5. In this case, a short block length is selected for the (j+2)th, and a long bock length is selected for any other frame. Unlike in the case of FIG. 7, no phase differences take place among the frames. No special process needs to be carried out prior to the MDCT.

As has been described, the block length set in the pre-process remains unchanged until the MDCT block length is changed, without causing phase differences, when MDCT is performed on, for example, aprediction-difference signal. In addition, the block length can be changed without causing phase differences even if the case where phase differences would occur if the block length were changed by the conventional method.

What is claimed is:

1. An orthogonal transform apparatus for performing orthogonal transform on input time domain samples, with overlapping the input time domain samples, the apparatus comprising:
means for performing orthogonal transform by specifying a boundary of occurring aliasing during inverse orthogonal transform, wherein the boundary á is selected within the range of 0=<á<M and M is the number of the time domain samples subjected to the orthogonal transform.

2. The apparatus according to the claim 1, wherein the boundary is aligned between adjacent frames.

3. The apparatus according to the claim 2, wherein the boundary is aligned between adjacent frames by selecting and applying an appropriate window function.

4. The apparatus according to the claim 3, wherein the window function contains no zero (0) components.

5. An orthogonal transform method of performing orthogonal transform on input time domain samples, with overlapping the input time domain samples, the method comprising step of:
performing orthogonal transform by specifying a boundary of occurring aliasing during inverse orthogonal transform, wherein the boundary áis selected within the range of 0=<á<M and M is the number of the time domain samples subjected to the orthogonal transform.

6. An inverse orthogonal transform apparatus for performing inverse orthogonal transform on orthogonal transform coefficients obtained by effecting orthogonal transform on time domain samples with overlapping the time domain samples,
wherein the orthogonal transform coefficients have been generated by specifying a boundary of occurring aliasing during inverse orthogonal transform, wherein the boundary á is selected within the range of 0=<á<M and M is the number of the time domain samples subjected to the orthogonal transform.

7. An inverse orthogonal transform method of performing inverse orthogonal transform on orthogonal transform coefficients obtained by effecting orthogonal transform on time domain samples with overlapping the time domain samples,
wherein the orthogonal transform coefficients have been generated by specifying a boundary of occurring aliasing during inverse orthogonal transform, wherein the boundary a is selected within the range of 0=<á <M and M is the number of the time domain samples subjected to the orthogonal transform.

8. A transform encoding apparatus for performing orthogonal transform on an input signal, thereby to compress and encode the input signal, said apparatus comprising:
prediction analysis means for fetching the input signal in units of a prescribed number of samples, and for effecting prediction analysis on the samples and for generating prediction residuals;
characteristic-determining means for determining characteristic of each unit of the prescribed number of samples;
block-length determining means for determining a block length M for orthogonal transform from said characteristic;
orthogonal transform means for specifying a boundary of occurring aliasing during inverse orthogonal transform corresponding to said block length wherein the boundary a, is selected within the range of 0=<á<M, and for performing orthogonal transform by using the specified boundary on M samples of said prediction residual with overlapping the samples, thereby generating orthogonal transform coefficients; and
quantization means for quantizing the orthogonal transform coefficients generated by the orthogonal transform means, thereby generating quantized data.

9. The apparatus according to claim 8, wherein the orthogonal transform -means aligns the boundary between adjacent frames, for the M samples that are subjected to the orthogonal transform.

10. The apparatus according to claim 9, wherein the orthogonal transform means aligns the boundary between adjacent frames, for the M samples that are subjected to the orthogonal transform, by selecting and applying an appropriate window function.

11. The apparatus according to the claim 10, wherein the window function contains no zero (0) components.

12. The apparatus according to claim 8, wherein the characteristic-determining means determines the constancy of each sample of the input signal.

13. The apparatus according to claim 12, wherein the block-length determining means renders the block length longer when the characteristic-determining means determines that the signal has quasi-constancy, changing with time only a little, than when the characteristic-determining means determines that the signal much changes with time.

14. The apparatus according to claim 8, wherein the input signal is an audio signal and/or an acoustic signal.

15. The apparatus according to claim 8, wherein the quantized data is output at the rate of 6 Kbps to 32 Kbps.

16. Atransform encoding method of performing orthogonal transform on an input signal, thereby to compress and encode the input signal, said method comprising the steps of:
prediction analysis step for fetching the input signal in units of a prescribed number of samples, effecting prediction analysis on the samples generating prediction residuals;
characteristic-determining step for determining characteristic of each unit of the prescribed number of samples;
block-length determining step for determining a block length M for orthogonal transform from said characteristic;
orthogonal transform step for specifying a boundary of occurring aliasing during inverse orthogonal transform corresponding to said block length, wherein the boundary á, is selected within the range of 0=<á<M and
for performing orthogonal transform by using the specified boundary on M samples of said prediction residual with overlapping the samples,
thereby generating orthogonal transform coefficients; and
quantization step for quantizing the orthogonal transform coefficients generated in the step of performing orthogonal transform, thereby generating quantized data.

17. A decoding apparatus for decoding quantized data generated by quantizing orthogonal transform coefficients produced by performing orthogonal transform on M samples of input signal with overlapping the samples,
the orthogonal transform using a specified boundary of occurring aliasing during inverse orthogonal transform corresponding to the block length determined by characteristic of the input signal, wherein the specified boundary á, is selected within the range of 0=<á<M
said apparatus comprising:
inverse quantization means for performing inverse quantization on the quantized data, thereby generating orthogonal transform coefficients; and
inverse orthogonal transform means for performing inverse orthogonal transform on the orthogonal transform coefficients generated by the inverse quantization means, by applying the block length determined from the characteristic of the input signal.

18. A decoding method of decoding quantized data generated by quantizing orthogonal transform coefficients produced by performing orthogonal transform on M samples of input signal with overlapping the samples
the orthogonal transform using a specified boundary of occurring aliasing during inverse orthogonal transform corresponding to the block length determined by characteristic of the input signal, wherein the specified boundary a, is selected within the range of 0=á<M
said method comprising the steps of:
performing inverse quantization on the quantized data, thereby generating orthogonal transform coefficients; and
performing inverse orthogonal transform on the orthogonal transform coefficients generated in the step of performing the inverse quantization, by applying the block length determined from the characteristic of the input signal.
